(19) United States
(12) Patent Application Publication
(10) Pub. No.: US 2004/0069261 A1
(43) Pub. Date: Apr. 15, 2004

(54) Porous duct configured with a thin film

(75) Inventor: Henri Lepoutre, Roubaix Cedex (FR)

Correspondence Address: Edward G. Greive, Renner, Kenner, Greive, Bobak, Taylor & Weber, Fourth Floor, First National Tower, Akron, OH, 44308-1456, US

(73) Assignee: Wecosta

(21) Appl. No.: 10/614,355

(22) Filed: Jul. 7, 2003

(30) Foreign Application Priority Data
Jul. 5, 2002 (FR) 0208441

(51) Int. Cl. F02M 35/10

(52) U.S. Cl. 123/184.61

(57) ABSTRACT

An intake duct 1 is provided, particularly for taking air in an internal combustion engine, notably the engine of an automobile. Said duct includes a first wall 2 made of a porous material, wherein a film 4 is implemented which is sufficiently thin for avoiding any incidence upon the acoustical characteristics, having notably a surface mass of less than 100 grams per square meter. Said film 4 is fixed onto said porous wall 2 such that at least 50% of the surface of said film facing said porous wall 2 is not fixed thereto.

### BACKGROUND OF THE INVENTION

1. Field of the Invention

The present invention relates to air intake ducts. More particularly, the present invention relates to intake ducts for the combustion air of an internal combustion engine in an automobile.

2. Description of the Related Art

Air intake ducts configured with a porous wall are known according to the known prior art. Said porous walls provide for better acoustic characteristics because the acoustical resonance of the air column delimited by the porous wall are largely dampened, unlike known plastic ducts with rigid and impervious walls. Indeed, pulses corresponding to the resonance frequencies within the air column may propagate to the outside by traversing said porous wall, which diminishes the intensity of the respective pressure and speed antinodes.

However, air intake ducts configured with porous walls according to the known prior art feature many disadvantages. Firstly, the porous wall is permeable to the warm air located for instance under the engine hood. Said warm air arriving within the cylinders after permeating said porous wall is detrimental to the power and/or torque performance of the engine. Secondly, ducts with porous walls of the known art feature some coarseness, from which a loss of load arises by means of the ducted air rubbing against the coarse wall thereof. Finally, it is necessary to include a very wide plastic oversleeve in such air intake ducting systems in order to obtain a sufficient imperviousness when immersed in water, which is very detrimental from an acoustical and style point of view, as well as with regard to the thermal ageing of the plastic material. Alternatively, it is imperative to soak the fibrous material forming the porous wall with a fluoride-based resin, which is an expensive and complicated solution from an industrial point of view and does not provide a uniform imperviousness over all the areas of the duct wall.

The present invention overcomes the disadvantages of ducts configured with a porous wall according to the known prior art by providing an air intake duct configured with acoustical characteristics as good as those of the ducts of the known prior art, but which is impervious to any external fluid (warm air or water), and features a minimal loss of load along the duct and is less expensive than the impervious acoustical ducts of the known prior art.

### BRIEF SUMMARY OF THE INVENTION

According to the present invention, there is provided an intake duct, particularly for taking air in an internal combustion engine, particularly that of an automobile, which includes a first wall made of a porous material, wherein a film is implemented, which is sufficiently thin for avoiding any incidence upon acoustical characteristics and has a surface mass of less than 100 grams per square metre, and said film is fixed to said porous wall such that at least a part, in particular at least 50%, of said film surface facing said porous wall is not fixed thereto.

Having regard to the fact that large portions of the surface of said film are not fixed onto the porous wall, said film does therefore not completely lay against the porous wall and may thus move under the influence of aerial pulses within the duct. Said film is a minimal obstructions to the propagation of waves pulsed through the porous wall by way of its lightness and, especially, its capacity to move. In effect, the aim is to strictly limit the role of this film to that of a fluid barrier.

According to a particularly economical and simple embodiment of the present invention, the film is fixed to the porous wall according to a pattern of points and/or lines. For instance, said film may be fixed to the wall at a plurality of points configured with a small diameter and arranged as a pattern, for example a square.

According to another example, said porous wall and film are fixed to one another along the lines configured as a pattern, for example a checked pattern.

According to a particularly advantageous embodiment the present invention and, particularly in the case where the duct shall be used in under-pressure, i.e. the case in which pressure within said duct is less than outside said duct, as is the case an engine intake duct, said film is located inside the duct formed by the porous wall. Indeed, in the opposite case, said film would be continually laid against the wall and thus form an obstructions to the propagation of waves because it would not be free. Having regard to the locating of said film made of a plastic material within the porous wall, said film is therefore protected, as is its physical integrity and, consequently, its imperviousness.

According to a particularly advantageous embodiment of the present invention, which is economical and simple to manufacture, said film is fixed to said porous wall by means of welding or gluing and, preferably, by means of ultrasonic welding.

### BRIEF DESCRIPTION OF THE SEVERAL VIEWS OF THE DRAWINGS

FIG. 1 shows a longitudinal cross-section of a duct according to the present invention; and

FIGS. 2A, 2B and 2C respectively illustrate examples of fixing or gluing or welding patterns for fixing the porous wall to the film of plastic material.

### WRITTEN DESCRIPTION OF THE BEST MODE FOR CARRYING OUT THE INVENTION

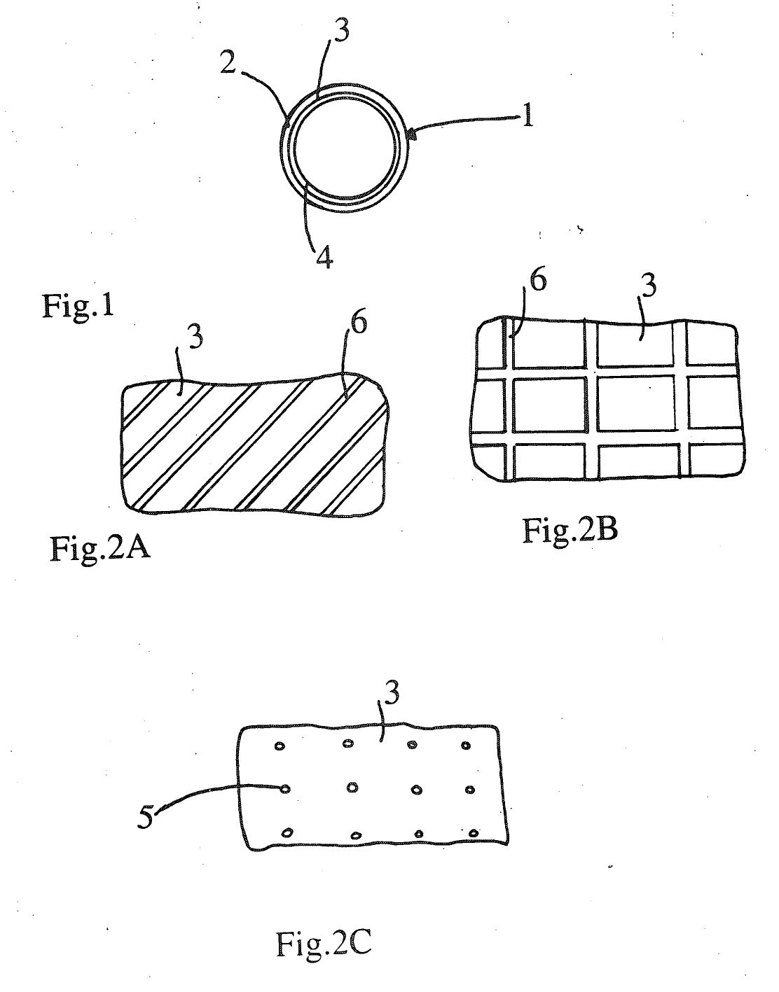

### FIG. 1

In FIG. 1, the air intake duct I of an internal combustion engine provides air to be combusted within said internal combustion engine. Said duct is shown in the figure with a tubular shape and comprises a first tubular wall 2 made of a porous material, i.e. having openings through which fluids may pass, wherein said material maybe any of the following: open-cell foam, woven fabric or nonwoven fabric.

The thickness of the porous wall generally lies between one millimetre and three millimetres. The diameter of the porous wall generally lies between forty millimetres and seventy millimetres. A film 4 made of a plastic material is fixed to the internal surface 3 of the tubular wall 2, wherein said material is notably in polyethylene, polypropylene, polyamide, polyester, or another. Said film made of plastic material is for instance configured with a thickness of 30 im.

Such a thickness is sufficiently thin for avoiding any incidence of the film of plastic material upon the accoustical characteristics of the combination of the porous wall with said film of plastic material, i.e. the surface mass is sufficiently low. The porous wall is generally made of a fibrous material, preferably a nonwoven fabric configured with synthetic or natural fibres.

The film of plastic material 4 is fixed inside against the internal surface of the porous wall 2. Said film 4 may also be fixed outside said porous wall, in the case of a duct to be used in over-pressure or equilibrated pressure.

### FIG. 2

In the preferred embodiment of the present invention, the fixing is performed by way of thermal welding following a network 5 of welding points, wherein each such point has for instance a diameter of 3 millimetres and said points are configured as a pattern of squares of 10 millimetres. In this embodiment, more than 90% of the internal surface between both walls are free of any relative movement. Consequently, acoustical resonance may be dampened by the porous wall as if there were no film of plastic material therein. Moreover, said film of plastic material prevents load losses linked to air rubbing against the fibrous material on the one hand and ensures imperviousness relative to the external warm air, which would otherwise be taken in by the engine. An engine with a better performance is therefore obtained.

According to alternative embodiments of the present invention, fixings by means of welding or gluing between the two walls may follow patterns configured with lines 6 and, preferably, following a rectangular checked pattern configured with squares or lozenges. Any other shape or pattern may be used so long as a sufficient surface of the interface between the two walls remains free of movement. Preferably, at least 50% of said interface surface should remain free of movement.

What is claimed is:

1. An intake duct (1), particularly for taking air in an internal combustion engine, notably the engine of an automobile, including a first wall (2) made of a porous material, wherein
a film (4) is implemented which is sufficiently thin for avoiding any incidence upon the acoustical characteristics, having notably a surface mass of less than 100 grams per square meter; and
said film (4) is fixed onto said porous wall (2) such that at least a part of the surface of said film facing said porous wall (2) is not fixed thereto.

2. An intake duct according to claim 1, wherein said film is fixed to said porous wall following a pattern of points (5) and/or lines (6).

3. An intake duct according to claim 1, wherein said film is fixed to said porous wall at a plurality of points configured with a small diameter and forming a pattern, which is preferably square.

4. An intake duct according to claim 1, wherein said film and said porous wall are fixed to one another along lines (6) forming a pattern, which is for instance checked.

5. An intake duct according to claim 1, wherein said film is located inside said porous wall.

6. An intake duct according to claim 1, wherein the fixing of said film to said porous wall is performed by way of welding or gluing and preferably by way of ultrasonic welding.

7. An intake duct according to claim 1, wherein said film (4) is made of polyethylene, polypropylene, polyamide, polyester or another plastic material.

8. An intake duct according to claim 1, wherein at least 50% of said film surface is not fixed to said porous wall.
